(19) United States
(12) Patent Application Publication
(10) Pub. No.: US 2016/0211735 A1
(43) Pub. Date: Jul. 21, 2016

(54) VIBRATION MOTOR

(71) Applicants: Lubin Mao, Shenzhen (CN); Shun Guo, Shenzhen (CN); Hongxing Wang, Shenzhen (CN)

(72) Inventors: Lubin Mao, Shenzhen (CN); Shun Guo, Shenzhen (CN); Hongxing Wang, Shenzhen (CN)

(73) Assignee: AAC Technologies Pte. Ltd., Singapore city (SG)

(21) Appl. No.: 14/979,421

(22) Filed: Dec. 27, 2015

(30) Foreign Application Priority Data
Jan. 16, 2015 (CN) 201520033482.0

(51) Int. Cl. H02K 33/00

(52) U.S. Cl. CPC H02K 33/00

(57) ABSTRACT

A vibration motor is provided in the present disclosure. The vibration motor includes a housing having a receiving space, and a vibrating part and a fixing part received in the receiving space. The vibrating part includes a plurality of magnets and a mass member for fixing the magnets. The fixing part includes a plurality of first coils which corresponding to the plurality of magnets for surrounding adjacent ends of two adjacent magnets, and an elastic connecting part for suspending the vibrating part in the housing. The elastic connecting part is connected between the mass member and the housing. Each of the magnets is magnetized along a vibration direction of the vibrating part, and adjacent ends of any two adjacent magnets have a same magnetic pole.

### FIELD OF THE DISCLOSURE

The present disclosure generally relates to vibration motors, and more particularly, to a vibration motor applicable to a portable electronic product.

### BACKGROUND

With the development of electronic technologies, portable electronic products such as mobile phones, handheld game players, navigation devices or handheld multimedia entertainment devices, become more and more popular. These electronic products generally use vibration motors to provide system feedbacks, such as incoming call prompting, message prompting, navigation prompting, and vibration feedback in game players.

A related vibration motor includes a housing, and a vibrating part and a fixing part that are received in the housing. The vibrating part includes two or more magnets and a mass block for fixing the magnets. The fixing part includes a coil and an elastic connecting part. Two opposite ends of the elastic connecting part connected with the housing and the mass block respectively.

The magnets are arranged to form a gap therebetween, and the coil is disposed at a side of the gap, moreover, polarization directions of the magnets is perpendicular to a vibration direction of the vibrating part.

With the above-mentioned configuration, most of magnetic lines of the magnets cannot pass through the coil, this may causes utilization efficiency of magnetic fields in the aforesaid vibration motor to be somewhat low.

Accordingly, it is necessary to provide a new vibration motor which can overcome the aforesaid problems.

### BRIEF DESCRIPTION OF THE DRAWINGS

FIG. 1 is a cross-sectional view of a vibration motor according to a first embodiment of the present disclosure;

FIG. 2 is a cross-sectional view of a vibration motor according to a second embodiment of the present disclosure;

FIG. 3 is a cross-sectional view of a vibration motor according to a third embodiment of the present disclosure; and

FIG. 4 is a cross-sectional view of a vibration motor according to a fourth embodiment of the present disclosure.

### DETAILED DESCRIPTION

Hereinbelow, the present disclosure will be further described with reference to the attached drawings and embodiments thereof.

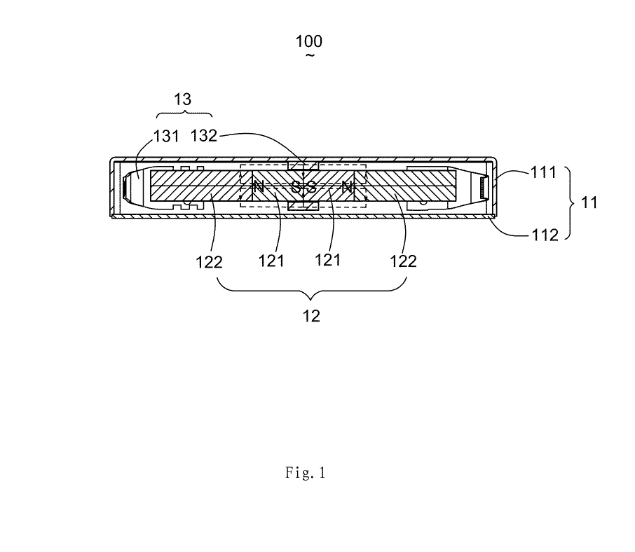

FIG. 1 is a cross-sectional view of a vibration motor according to a first embodiment of the present disclosure. The vibration motor 100 includes a housing 11, a vibrating part 12 and a fixing part 13.

The housing 11 includes a cover 111 and a bottom plate 112. The cover 111 engages and cooperates with the bottom plate 112, for forming a receiving space for receiving the vibrating part 12 and the fixing part 13.

The vibrating part 12 includes two or more magnets 121 and a mass member 122. In the present embodiment, two magnets 121 are disposed in parallel along a vibration direction (e.g., a horizontal direction) of the vibrating part 12. The mass member 122 is used to fix the magnets 121.

In one embodiment, the mass member 122 may be a single block with at least one receiving holes for receiving the two magnets 121. Alternatively, in another embodiment, the mass member 122 includes two or more fixing blocks cooperating with each other to fix the two magnets 121. Both the two magnets 121 are magnetized along the vibration direction (e.g., the horizontal direction) of the vibrating part 12, and the two magnets 121 may be placed such that an S-pole or an N-pole of a magnet 121 is adjacent to a same pole of the other magnet 121. In other words, adjacent ends of the two magnets 121 have a same polarity, e.g., both being S-poles or both being N-poles.

The fixing part 13 includes an elastic connecting part 131 and a first coil 132. The elastic connecting part 131 is used to suspend the vibrating part 12 in the housing 11. The first coil 132 partly surrounds both of the magnets 121, for example, the first coil 132 may surround the adjacent ends of the two magnets 121. The elastic connecting part 131 may include two elastic connectors for suspending two opposite ends of the mass member 122, each of the elastic connectors has a first end connected with a corresponding edge of the mass member 122, and a second end connected with an inner sidewall of the cover 111 adjacent to the corresponding edge of the mass member 122. The first coil 132 may be fixed to either an inner surface of the cover 111 or an inner surface of the bottom plate 112.

Magnetic lines of the two magnets 121 form four small cycles (as shown by the four dashed boxes in FIG. 1) which pass through the first coil 132. When being energized, the first coil 132 experiences an electromagnetic force (which is known as Lorentz force) with a direction substantially the same as the vibration direction of the vibrating part 12 according to a well-known left-hand rule. Because the first coil 132 is fixed to the housing 11, the magnets 121 and the mass member 122 are actuated to vibrate along the horizontal direction due to the electromagnetic force. The elastic connecting part 131 provides a restoring force for the vibrating part 12 to pull the vibrating part 12 back to an original position, and also guides the vibrating part 12 to vibrate within a desired range.

As illustrated in FIG. 1, with the above-described configuration, mort of the magnetic lines provided by the magnets 121 pass through the first coil 132, and therefore, utilization efficiency of magnetic fields in the vibration motor 100 is improved.

Furthermore, in the present embodiment, the adjacent ends of the two magnets 121 may abut against each other. Alternatively, the two magnets 121 may be arranged in such a manner that a gap exists between the adjacent ends of the two magnets 121 in other embodiments, and accordingly the gap is surrounded by the first coil 132. According to characteristics of the magnetic field, because the adjacent ends of the two magnets 121 have a same polarity, the magnetic lines output from a magnet 121 enter the other magnet 121, and therefore are all distributed in the gap between the two magnets 121. That is, all of the magnetic lines pass through the gap. Since the first coil 132 surrounds the gap, the magnetic lines all pass through the first coil 132. As such, utilization efficiency of magnetic fields in the vibration motor 100 can further be improved.

Optionally, the vibration motor 100 may further includes second coils surrounding connecting regions between the magnets 121 and the mass member 122, and the second coils are connected with the cover 111. The second coils can further improve utilization efficiency of magnetic fields in the vibration motor 100.

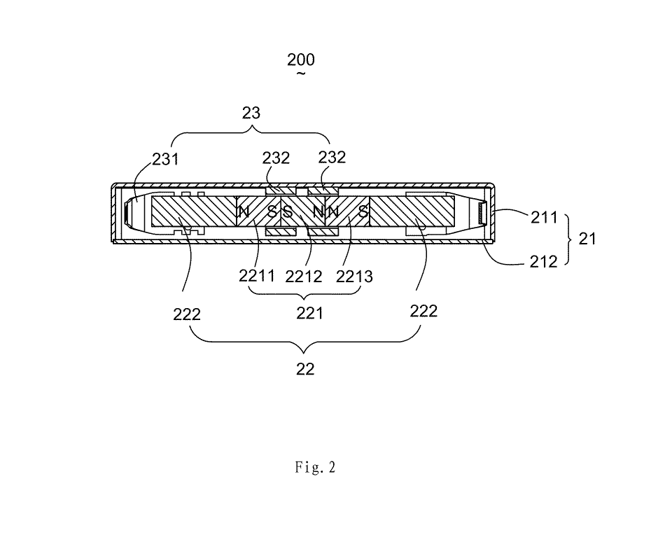

Referring to FIG. 2, a vibration motor 200 according to a second embodiment of the present disclosure includes a housing 21 with a cover 211 and a bottom plate 212. The cover 211 is engaged with the bottom plate 212, and cooperates with the bottom plate 212 to form a receiving space for receiving the vibrating part 22 and the fixing part 23.

The vibrating part 22 includes a plurality of magnets 221 and a mass member 222. In the present embodiment, three magnets 221 (namely, a first magnet 2211, a second magnet 2212 and a third magnet 2213) are taken as another example. The first magnet 2211, the second magnet 2212 and the third magnet 2213 are disposed in parallel along a vibration direction (e.g., a horizontal direction) of the vibrating part 22. The mass member 222 is used to fix the magnets 221.

The mass member 222 may be a signal block with at least one receiving holes for receiving the magnets 221. Alternatively, in another embodiment, the mass member 222 includes two or more fixing blocks to fix the magnets 221 respectively.

All the three magnets 221 are magnetized along the vibration direction (e.g., the horizontal direction) of the vibrating part 22, and adjacent ends of any two adjacent magnets 221 have a same polarity, e.g., both being S-poles or both being N-poles. Along a direction pointing from the left to the right in FIG. 2, the adjacent ends of the first magnetic 221 and the second magnetic 221 are both S-poles, and the adjacent ends of the second magnetic 221 and the third magnetic 221 are both N-poles. In other words, each two adjacent magnetic 221 may be placed such that an S-pole or N-pole of one magnet 221 is adjacent to a same pole of the other adjacent magnet 121.

The fixing part 23 includes an elastic connecting part 231 and two first coils 232. The elastic connecting part 231 is used to suspend the vibrating part 22 in the housing 21. One of the two first coils 232 partly surrounds the adjacent ends of the first magnetic 2211 and the second magnetic 2212, and the other one of the two first coils 203 partly surrounds the adjacent ends of the second magnetic 2212 and the third magnetic 2213.

The elastic connecting part 231 may include two elastic connectors for suspending two opposite ends of the mass member 222, each of the elastic connectors has a first end connected with a corresponding side edge of the mass member 222, and a second end connected with an inner sidewall of the cover 211 adjacent to the corresponding edge of the mass member 222. The first coils 232 may be fixed to either an inner surface of the cover 211 or an inner surface of the bottom plate 212.

Similar to the first embodiment, magnetic lines of the three magnets 221 form six small cycles which pass through the respective first coils 232. When being energized, the first coils 232 each experience an electromagnetic force (which is known as Lorentz force) with a direction substantially the same as the vibration direction of the vibrating part 22 according to a well-known left-hand rule. Because the first coils 232 are fixed to the housing 21, the magnets 221 and the mass member 222 are actuated to vibrate due to the electromagnetic force. The elastic connecting part 231 provides a restoring force for the vibrating part 22 to pull the vibrating part 22 back to an original position, and also guides the vibrating part 22 to vibrate within a desired range along the horizontal direction.

Mort of the magnetic lines provided by the magnets 221 pass through the first coils 232, and therefore, utilization efficiency of magnetic fields in the vibration motor 200 is improved.

Furthermore, in the present embodiment, the adjacent ends of any two adjacent ones of the three magnets 221 may abut against each other. Alternatively, each two adjacent magnets may be arranged in such manner that a gap exists between the adjacent ends in other embodiments, and accordingly the gap is surrounded by a corresponding one of the first coils 232. According to properties of the magnetic field, because the adjacent ends of the two magnets 221 have a same polarity, the magnetic lines output from a magnet 221 enter the other magnet 221, and therefore are all distributed in the gap between the two magnets 221. That is, all of the magnetic lines pass through the gap. Since the first coil 232 surrounds the gap, the magnetic lines all pass through the first coil 232. As such, utilization efficiency of magnetic fields in the vibration motor 200 can further be improved.

Optionally, the vibration motor 200 may further includes second coils surrounding the connecting regions between the magnets 221 and the mass member 222, and the second coils are connected with the cover 211. The second coils can further improve utilization efficiency of magnetic fields in the vibration motor 200.

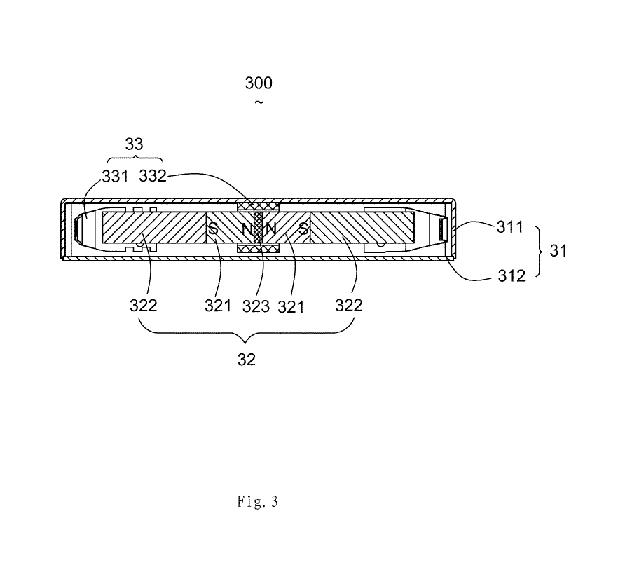

Referring to FIG. 3, a vibration motor 300 according to a third embodiment of the present disclosure includes a housing 31, a vibrating part 32 and a fixing part 33. The housing 31 includes a cover 311 and a bottom plate 312. The cover 311 engages and cooperates with the bottom plate 312 for forming a receiving space for receiving the vibrating part 32 and the fixing part 33.

The vibrating part 32 includes two magnets 321, a mass member 322 and a connecting body 323. The two magnets 321 are disposed in parallel and spaced apart along a vibration direction of the vibrating part 32 to form a gap therebetween. The mass member 322 is used to fix the magnets 321.

Both the two magnets 321 are magnetized along the vibration direction (e.g., a horizontal direction) of the vibrating part 32, and adjacent ends of the two magnets 321 have a same polarity, e.g., both being S-poles or both being N-poles. In other words, the two magnets 321 may be placed such that an S-pole or N-pole of a magnet 321 is adjacent to a same pole of the other magnet 321.

In one embodiment, the mass member 322 may be a single block with at least one receiving holes for receiving the two magnets 321. Alternatively, in another embodiment, the mass member 322 includes two or more fixing blocks cooperating with each other to fix the two magnets 321.

The connecting body 323 is received in the gap between adjacent ends of the two magnets 321. The connecting body 323 is made of soft magnetic material, magnetically permeable material or a magnetically non-permeable material, and is not limited in shape.

The fixing part 33 includes an elastic connecting part 331 and a first coil 332. The first coil 332 partly surrounds both of magnets 321. The elastic connecting part 331 may include two elastic connectors for suspending two opposite ends of the mass member 322 respectively, each of the elastic connectors has a first end connected with a corresponding edge of the mass member 322, and a second end connected with an inner sidewall of the cover 311 adjacent to the corresponding edge of the mass member 322. The first coil 332 may be fixed to either an inner surface of the cover 311 or an inner surface of the bottom plate 312.

Magnetic lines of the two magnets 121 form four small cycles which pass through the first coil 332. When being energized, the first coil 332 experiences an electromagnetic force (which is known as Lorentz force) with a direction substantially the same as the vibration direction of the vibrating part 32 according to a well-known left-hand rule. Because the first coil 332 is fixed to the housing 31, the magnets 321 and the mass member 322 are actuated to vibrate along the horizontal direction due to the electromagnetic force. The elastic connecting part 331 provides a restoring force for the vibrating part 32 to pull the vibrating part 32 back to an original position, and also guides the vibrating part 32 to vibrate within a desired range.

Mort of the magnetic lines provided by the magnets 321 pass through the first coil 332, and therefore, utilization efficiency of magnetic iii fields in the vibration motor 300 is improved.

Optionally, the vibration motor 300 may further includes second coils surrounding connecting regions between the magnets 321 and the mass member 322, and the second coils are connected with the cover 311. The second coils can further improve utilization efficiency of magnetic fields in the vibration motor 300.

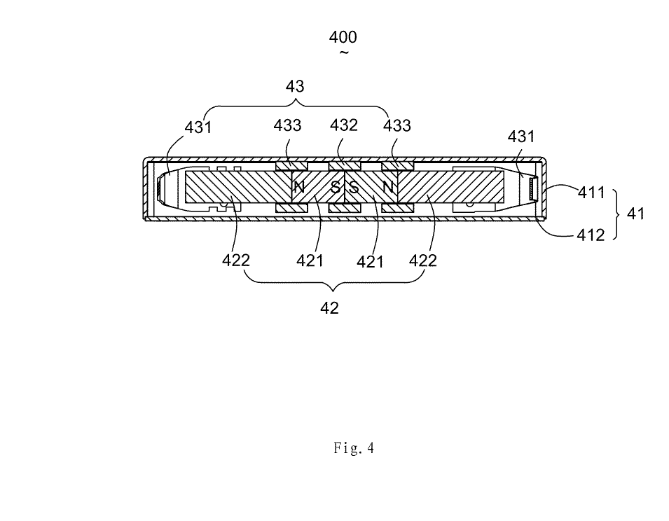

Referring to FIG. 4, a vibration motor 400 according to a fourth embodiment of the present disclosure includes a housing 41, a vibrating part 42 and a fixing part 43. The housing 41 includes a cover 411 and a bottom plate 412. The cover 411 is engaged with the bottom plate 412, and cooperates with the bottom plate 412 to form a receiving space for receiving the vibrating part 42 and the fixing part 43 therein.

The vibrating part 42 includes two magnets 421 and a mass member 422. The two magnets 421 are disposed in parallel and spaced apart along a vibration direction of the vibrating part 42. The mass member 422 is used to fix the magnets 421. The mass member 422 may be a signal block with at least one receiving holes for receiving the magnets 421. Alternatively, in another embodiment, the mass member 422 includes two or more fixing blocks to fix the magnets 421 respectively. Both the two magnets 421 are magnetized along the vibration direction (e.g., the horizontal direction) of the vibrating part 42, and adjacent ends of any two adjacent magnets 421 have a same polarity, e.g., both being S-poles or both being N-poles.

The fixing part 43 includes an elastic connecting part 431, a first coil 432 and two second coils 433. The elastic connecting part 431 is used to suspend the vibrating part 42 in the housing 41. The first coil 432 partly surrounds the adjacent ends of the magnets 421. The elastic connecting part 431 may include two elastic connectors for suspending two opposite ends of the mass member 422 respectively, each of the elastic connectors has a first end connected with a corresponding side edge of the mass member 422, and a second end connected with an inner sidewall of the cover 411 adjacent to the corresponding edge of the mass member 422. The first coil 432 may be fixed to either an inner surface of the cover 411 or an inner surface of the bottom plate 412.

The two second coils 433 partly surround the adjacent ends of the mass member 422 and the magnets 421 respectively, and are connected with the cover 411 respectively. The second coils 433 can further increase utilization efficiency of magnetic fields in the vibration motor 400.

Magnetic lines of the two magnets 421 form four small cycles which pass through the first coil 432. When being energized, the first coil 432 experiences an electromagnetic force (which is known as Lorentz force) with a direction substantially the same as the vibration direction of the vibrating part 42 according to a well-known left-hand rule. Because the first coil 432 is fixed to the housing 41, the magnets 421 and the mass member 422 are actuated to vibrate along the horizontal direction due to the electromagnetic force. The elastic connecting part 431 provides a restoring force for the vibrating part 42 to pull the vibrating part 42 back to an original position, and also guides the vibrating part 42 to vibrate within a desired range.

Mort of the magnetic lines provided by the magnets 421 pass through the first coil 432, and therefore, utilization efficiency of magnetic fields in the vibration motor 400 is improved.

In the present embodiment, the adjacent ends of the two magnets 421 may abut against each other, alternatively, the two magnets 421 may be arranged in such a manner that a gap exists between the adjacent ends of the two magnets 421 in other embodiments, and accordingly the gap is surrounded by the first coil 432. According to characteristics of the magnetic field, because the adjacent ends of the two magnets 421 have a same polarity, the magnetic lines output from a magnet 421 enter the other magnet 421, and therefore are all distributed in the gap between the two magnets 421. That is, all of the magnetic lines pass through the gap. Since the first coil 432 surrounds the gap, the magnetic lines all pass through the first coil 432. As such, utilization efficiency of magnetic fields in the vibration motor 400 can further be improved.

In summary, the vibrating part includes N magnets and a mass member for fixing the magnets, and the number of the magnets may be two or more. The fixing part includes N−1 first coils, and an elastic connecting part for suspending the magnets and the mass member in the housing. The magnetization direction of all the N magnets is same as a vibration direction of the vibrating part, adjacent ends of any two adjacent ones of the magnets have the same polarity, and the N−1 first coils surround adjacent ends of any two adjacent ones of the magnets respectively.

What described above are only embodiments of the present disclosure, and it shall be noted that, modifications may be made by those of ordinary skill in the art without departing from the inventive concepts of the present disclosure, and all these modifications shall fall within the scope of the present disclosure.

What is claimed is:

1. A vibration motor, comprising:
a housing having a receiving space; and
a vibrating part and a fixing part being received in the receiving space;
the vibrating part comprising:
a plurality of magnets and a mass member for fixing the magnets;
the fixing part comprising:
a plurality of first coils corresponding to the plurality of magnets for surrounding adjacent ends of two adjacent magnets, and
an elastic connecting part for suspending the vibrating part in the housing, the elastic connecting part being connected between the mass member and the housing,
wherein each of the magnets is magnetized along a vibration direction of the vibrating part, and adjacent ends of two adjacent magnets have a same magnetic pole.

2. The vibration motor of claim 1, wherein the adjacent ends of any two adjacent magnets abut against each other.

3. The vibration motor of claim 1, wherein the adjacent ends of any two adjacent magnets are spaced apart from each other for forming a gap therebetween.

4. The vibration motor of claim 3, further comprising at least one connecting body, each of the at least one connecting body being disposed in the gap between the adjacent ends of any two adjacent magnets.

5. The vibration motor of claim 4, wherein the at least one connecting body is made of soft magnetic material, magnetically permeable material, or magnetically non-permeable material.

6. The vibration motor of claim 1, wherein the housing includes a cover and a bottom plate that cooperate with each other to form the receiving space, and the first coils are fixed onto an inner surface of the cover.

7. The vibration motor of claim 1 further comprising a plurality of second coils surrounding the connections between the magnets and the mass member respectively.

8. The vibration motor of claim 7, wherein the second coils are connected with the cover.
